(19) United States
(12) Patent Application Publication
(10) Pub. No.: US 2009/0113339 A1
(43) Pub. Date: Apr. 30, 2009

(54) ELECTRONIC CALCULATOR DISPLAYABLE WITH REPEATING DECIMAL

(75) Inventors: Yoshinaga MIYAZAWA, Kawasaki-shi (JP); Hiroshi UEJIMA, Tokyo (JP); Satomi MIDOROGI, Iruma-shi (JP); Fumio GOTOH, Tokyo (JP); Nobuyoshi NISHIZAKA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/260,288

(22) Filed: Oct. 29, 2008

(30) Foreign Application Priority Data
Oct. 31, 2007 (JP) P2007-283554

(51) Int. Cl. G06F 3/048; G06F 3/00

(52) U.S. Cl. 715/784; 708/171; 708/170

(57) ABSTRACT

An electronic calculator includes: a display device; a user interface; a memory device; and a processor that is operable with the memory device to: perform a calculation to convert a fractional number into a decimal number; control the display device to display the decimal number, when the decimal number is a repeating decimal, with a symbol indicating a periodic block included in the repeating decimal control the display device to display a scroll indicator indicating that the displayed repeating decimal is scrollable when the number of digits included in the repeating decimal overflows the number of digits displayable by the display device; control the display device to display an undisplayed part of the repeating decimal to scroll in when a scroll command is input by the user through the user interface while the scroll indicator is displayed.

### CROSS-REFERENCE TO THE RELATED APPLICATION(S)

The present application is based upon and claims priority from prior Japanese Patent Application No. 2007-283554, filed on Oct. 31, 2007, the entire content of which are incorporated herein by reference.

### TECHNICAL FIELD

The present invention relates to an electronic calculator that displays repeating decimal.

### BACKGROUND

When displaying a calculation result including a decimal part in a conventional electronic calculator of a small type, the calculation result is displayed for a displayable number of digits and overflowed digits are omitted in a case where the calculation result has a decimal part of a large number of digits. This also applies to a case when the calculation result includes a repeating decimal part, and only the digits that fit in the displayable number of digits are displayed.

In view of the circumstances, there is proposed a calculator that displays repeating decimals with a symbol(s) that indicates a periodic block having digits that are periodic. An example of such calculator is disclosed in JP-A-2000-122978.

As described above, in the conventional electronic calculators, there is proposed to display repeating decimals in such a manner that its periodic block is displayed together with a symbol(s) that allows a user to recognize the periodic block. However, in a case where the periodic block has a length that exceeds the number of displayable digits, a user cannot recognize the whole digits of the periodic block.

### SUMMARY

According to a first aspect of the invention, there is provided an electronic calculator including: a display device that displays characters including numerical characters; a user interface that allows a user to input operational commands; a fractional number display module that controls the display device to display a given fractional number; a conversion module that converts the fractional number into a decimal number; a repeating decimal determination module that determines whether the decimal number is a repeating decimal; a decimal number display module that controls the display device to display the decimal number; a periodic block indication module that controls the display device to display a symbol with the decimal number when the repeating decimal determination module determines that the decimal number is the repeating decimal, the symbol indicating a periodic block included in the repeating decimal; a display digit determination module that determines whether the number of digits included in the repeating decimal overflows the number of digits displayable by the display device; an indicator display module that controls the display device to display a scroll indicator indicating that the displayed repeating decimal is scrollable when the display digit determination module determines that the number of digits included in the repeating decimal overflows the number of digits displayable by the display device; and a scrolling display module that controls the display device to display an undisplayed part of the repeating decimal to scroll in when a scroll command is input by the user through the user interface while the scroll indicator is displayed.

According to a second aspect of the invention, there is provided a computer-readable storage medium containing a sequence of instructions for a program executable by a computer system, the program including: instructions for controlling a display device to display characters including numerical characters; instructions for allowing a user to input operational commands; instructions for controlling the display device to display a given fractional number; instructions for converting the fractional number into a decimal number; instructions for determining whether the decimal number is a repeating decimal; instructions for controlling the display device to display the decimal number; instructions for controlling the display device to display a symbol with the decimal number when determined that the decimal number is the repeating decimal, the symbol indicating a periodic block included in the repeating decimal; instructions for determining whether the number of digits included in the repeating decimal overflows the number of digits displayable by the display device; instructions for controlling the display device to display a scroll indicator indicating that the displayed repeating decimal is scrollable when determined that the number of digits included in the repeating decimal overflows the number of digits displayable by the display device; and instructions for controlling the display device to display an undisplayed part of the repeating decimal to scroll in when a scroll command is input by the user through the user interface while the scroll indicator is displayed.

According to a third aspect of the invention, there is provided an electronic calculator including: means for displaying characters including numerical characters on a display device; means for allowing a user to input operational commands; means for controlling the display device to display a given fractional number; means for converting the fractional number into a decimal number; means for determining whether the decimal number is a repeating decimal; means for controlling the display device to display the decimal number; means for controlling the display device to display a symbol with the decimal number when determined that the decimal number is the repeating decimal, the symbol indicating a periodic block included in the repeating decimal; means for determining whether the number of digits included in the repeating decimal overflows the number of digits displayable by the display device; means for controlling the display device to display a scroll indicator indicating that the displayed repeating decimal is scrollable when determined that the number of digits included in the repeating decimal overflows the number of digits displayable by the display device; and means for controlling the display device to display an undisplayed part of the repeating decimal to scroll in when a scroll command is input by the user while the scroll indicator is displayed.

According to a fourth aspect of the invention, there is provided an electronic calculator including: a display device that displays characters including numerical characters; a user interface that allows a user to input operational commands; a memory device that stores data for a calculation; and a processor that is operable with the memory device to: perform the calculation to convert a fractional number into a decimal number; control the display device to display the decimal number, when the decimal number is a repeating decimal, with a symbol indicating a periodic block included in the repeating decimal control the display device to display a scroll indicator indicating that the displayed repeating decimal is scrollable when the number of digits included in the repeating decimal overflows the number of digits displayable by the display device; control the display device t display an undisplayed part of the repeating decimal to scroll in when a scroll command is input by the user through the user interface while the scroll indicator is displayed.

### BRIEF DESCRIPTION OF THE DRAWINGS

In the accompanying drawings:

FIG. 1 is a block diagram showing a configuration of an electronic circuit of an electronic calculator according to an embodiment of a repeating decimal display apparatus of the present invention;

FIG. 2 shows an example of a periodic block notation database that is stored in a ROM of the electronic calculator;

FIGS. 3A-3D show examples notations of repeating decimals being converted into respective notations for target countries by a conversion program run on the electronic calculator;

FIG. 4 is a flowchart of a main process for converting and displaying the repeating decimals;

FIG. 5 is a flowchart of a detail of the process for converting fractions into repeating decimals; and

FIG. 6 shows an example of display operations that are performed in response to a user's input.

### DETAILED DESCRIPTION

An embodiment according to the present invention will be described in detail with reference to the accompanying drawings. The scope of the claimed invention should not be limited to the examples illustrated in the drawings and those described in below.

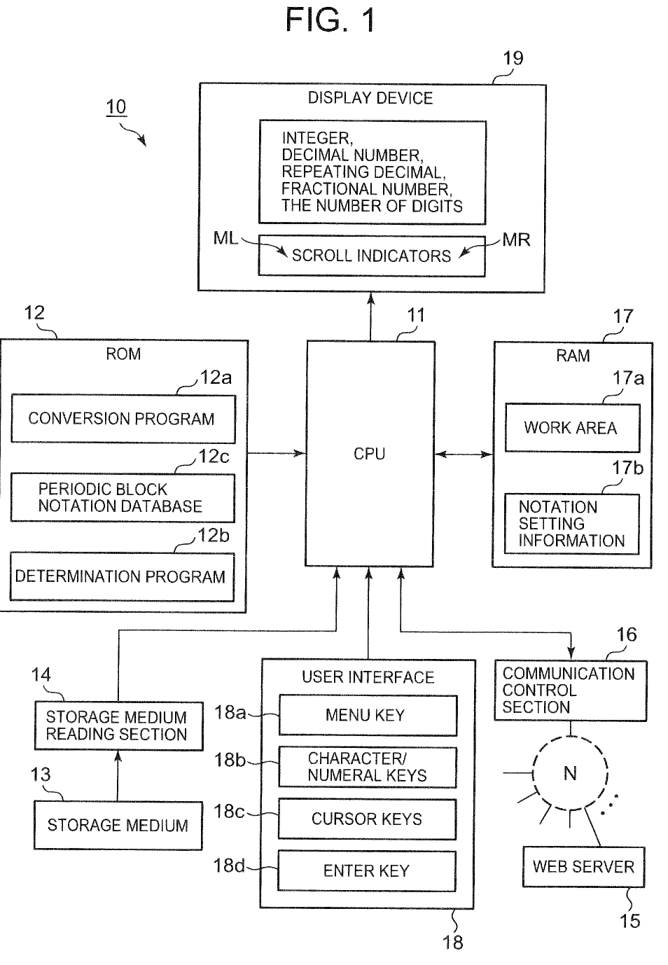

FIG. 1 is a block diagram showing a configuration of an electronic circuit of an electronic calculator 10 according to an embodiment of a repeating decimal display apparatus of the present invention.

The electronic calculator 10 is equipped with a processor (CPU) 11.

The processor 11 controls other components in accordance with a set of programs by using a RAM 17 as a work area. The set of programs include: a system program that is preliminarily stored in a ROM 12; and an calculator control program that is stored into the ROM (flash memory) 12 from an external storage medium 13 such as a memory card by a storage medium reading unit 14. The calculator control program may be downloaded from a web server (program server) on a communication network N via a network interface 16 to be stored into the ROM (flash memory) 12. The system program and the calculator control program stored in the ROM 12 is activated in response to a key input signal output from a user interface 18.

The processor (CPU) 11 is connected to other components including the ROM 12, the storage medium reading unit 14, the network interface 16, the RAM 17, the user interface 18, and a display device 19.

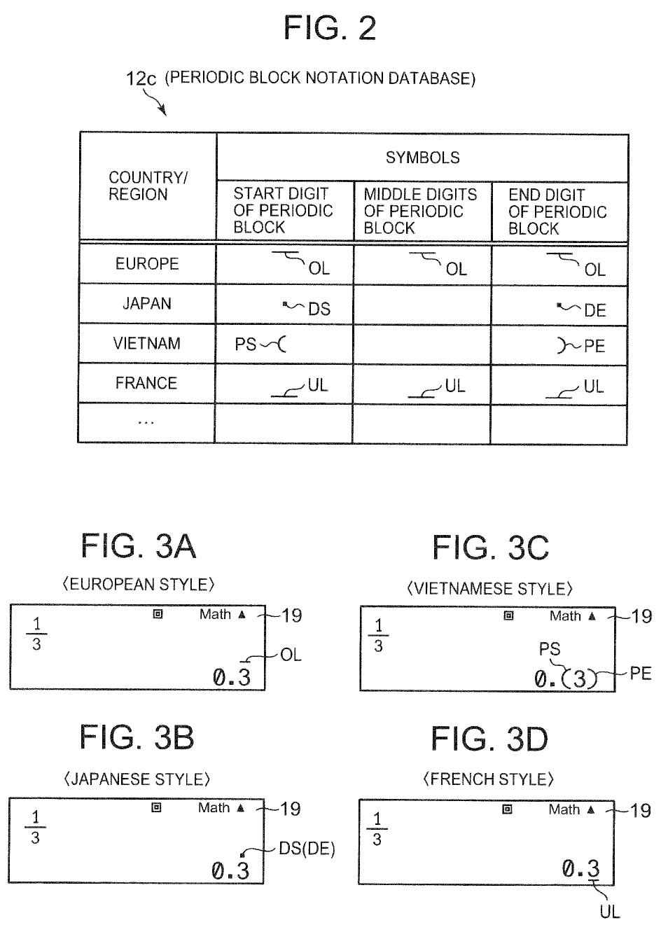

The ROM 12 stores the calculator control program for controlling the entire operation of the electronic calculator 10 and the calculator control program including a conversion program 12a and a determination program 12b. The conversion program 12a is for converting a fractional number, which is obtained by the user's direct input through the user interface or as a result of a calculation performed by the processor 11, into a decimal number, which is one of an integer, a non-repeating decimal, and a repeating decimal. The determination program 12b is for determining a repeating decimal, which is obtained through the conversion performed by the conversion program 12a, overflows displayable digits of the display device 191. The ROM 12 also stores a periodic block notation database 12c. The detail of the periodic block notation database 12c is shown in FIG. 2.

FIG. 2 shows the detail of the periodic block notation database 12c that is stored in the ROM 12 of the electronic calculator 10.

As shown in FIG. 2, the periodic block notation database 12c stores a prescribed symbols or symbol pairs for indicating a periodic block of the repeating decimal for each of a plurality of countries/regions where the electronic calculator 10 is to be used.

FIGS. 3A-3D show examples of notations for a repeating decimal into which conversion is made by the conversion program 12a, the example notations being different from one another for each countries/regions.

FIGS. 3A-3D show examples of a case in which a fractional number “⅓” is converted into a decimal number “0.3333 . . . ,” which includes a repeating decimal having a 1-digit periodic block.

For example, in a European notation style, an overline OL is displayed over all of the digits configuring the periodic block as shown in FIG. 3A. In a Japanese notation style, a pair of dots DS and DE is displayed over the start digit and the end digit of the periodic block as shown in FIG. 3B. In a Vietnamese notation style, a pair of parentheses PS and PE is displayed to enclose the periodic block as shown in FIG. 3C. In a French notation style, an underline UL is displayed under all of the digits configuring the periodic block as shown in FIG. 3D.

The user interface 18 is equipped with a plurality of keys including a menu key 18a, character/numeral input keys 18b, left and right cursor keys 18c, and an enter key 18d. The menu key 18a is a key to be pressed for displaying a menu to select various calculation modes provided in the electronic calculator 10. The character/numeral input keys 18b are keys to be pressed for inputting various alphabetical and numerical characters. The left and right cursor keys 18c are keys to be pressed for moving an input position indicated by a cursor C displayed on the display device 19 or to scroll a display range displayed on the display device 19. The enter key 18d is a key to be pressed to enter input data or to enter commands for performing the calculation.

The RAM 17 is allocated with a work area 17a for temporarily storing various data that are input to and output from the processor 11 as various calculations are performed. The RAM 17 stores a notation setting information 17b for setting a desired notation style to be used from among those indicated in the periodic block notation database 12c in accordance with a country or a region where the electronic calculator 10 is used.

The notation setting information 17b may be configured to be set in accordance with a setting command input by the user through the user interface 18.

In the embodiment, the display device 19 is configured as a dot-matrix display that is capable to display 16 digits (characters) of alphabetic and numeric characters for each of three rows. A liquid crystal display (LCD) panel may be employed as the display device 19.

The display device 19 displays an integer, a decimal number, or a fractional number as the various calculations are performed. The display device 19 displays, when displaying a repeating decimal, the number of digits of the periodic block in the repeating decimal. Furthermore, when determined by the determination program 12b that the number of digits of the repeating decimal to be displayed exceeds the number of displayable digits, the display device 19 displays scroll indicators ML or MR indicating the displayed decimal is scrollable toward a hidden part (undisplayed part) that is not displayed on the display device 19.

Next, a process performed by the processor 11 in accordance with the conversion program will be described.

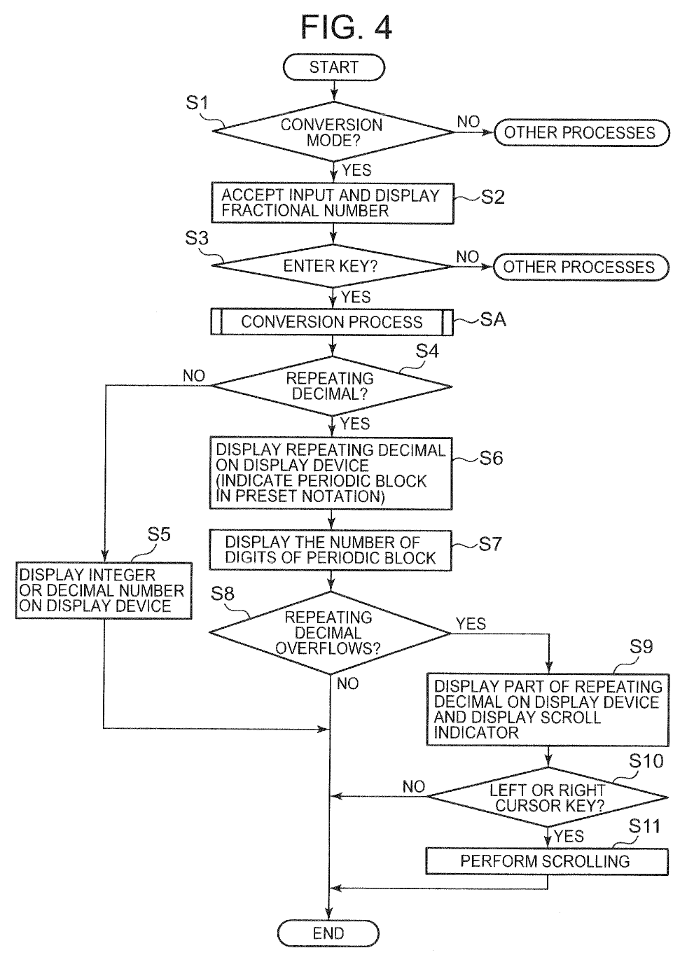

FIG. 4 is a flowchart of a main process for converting and displaying the repeating decimals.

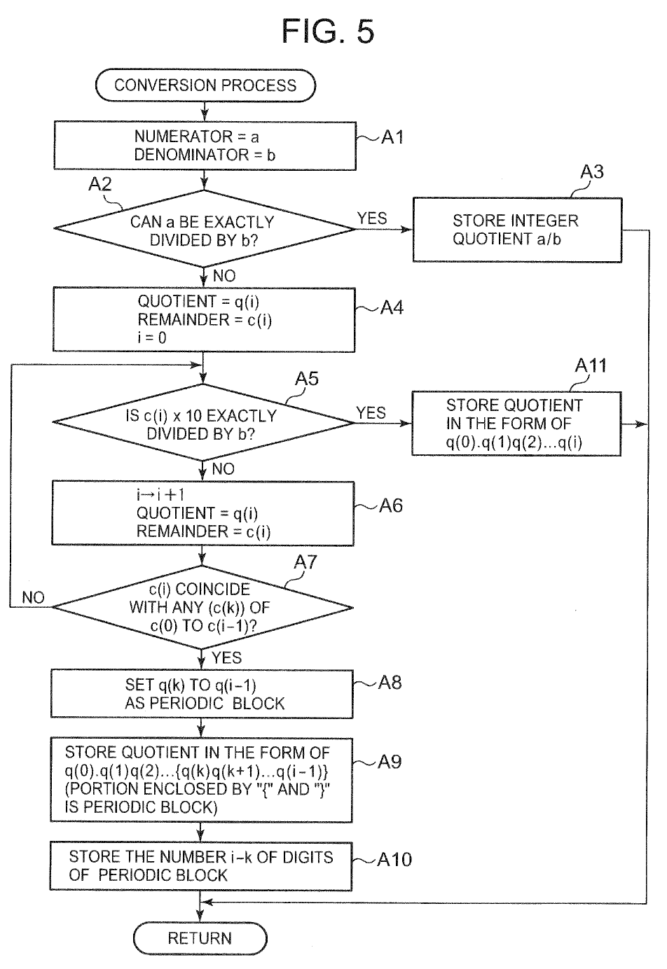

FIG. 5 is a flowchart of a detail of the process for converting fractions into repeating decimals.

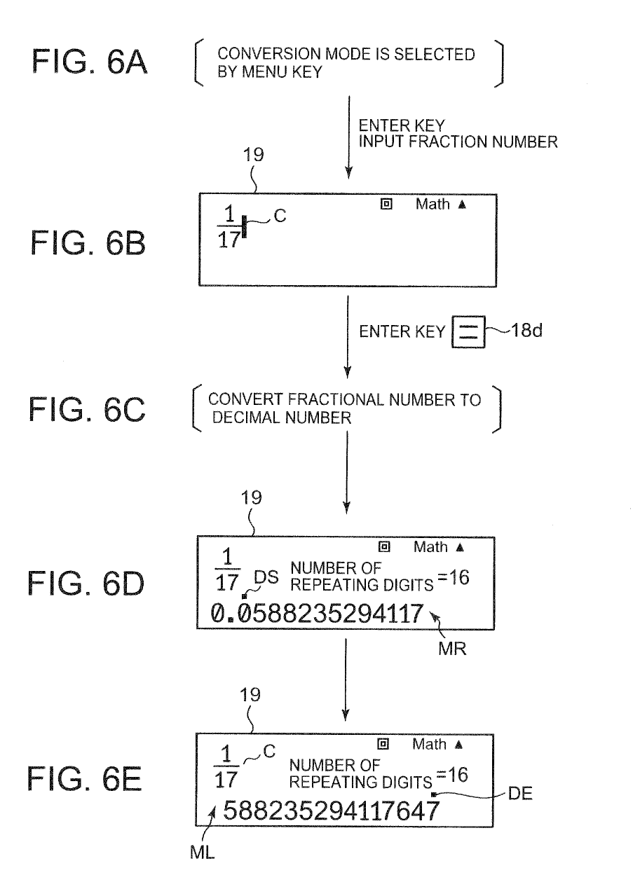

FIG. 6 shows an example of display operations that are performed in response to a user's input.

For example, as shown in section (A) in FIG. 6, a conversion mode for converting fractional numbers into numerical numbers is set by being selected by the user through an operation input to the user interface 18 while the menu is displayed on the display device 19 in response to the user's operation pressing the menu key 18a (step S1: YES).

In the conversion mode, it is assumed that a fractional number “ 1/17” is obtained, as shown in FIG. 6B, by the calculation performed in response to the user's operation or by the user's direct input (step S2). Under this state, when the enter key “=” 18d is pressed to display a decimal number of “ 1/17,” the conversion program 12a that is preliminarily stored in ROM 12 is activated as shown in FIG. 6C, and the process transitions, as shown in step SA in FIG. 4, to a conversion process for converting the fractional number into the decimal number, which is performed by the processor 11 in accordance with the conversion program 12a.

Upon the activation of the conversion process, first, the numerator “1” and the denominator “17” of the currently displayed fractional number “ 1/17” are substituted with “a” and “b, respectively (step A1), and it is determined whether the numerator “a” (=1) can be exactly divided by the denominator “b” (=17) (step A2).

If it is determined that the numerator “a” can be exactly divided by the denominator “b” (step A2: YES), the quotient [a/b] which should be an integer is stored in the work area 17a of the RAM 17 (step A3).

On the other hand, when determined that the numerator “a” (=1) cannot be exactly divided by the denominator “b” (=17) (step A2: NO), the quotient “0” is substituted into q(i), the remainder “1” is substituted into c(i), and the variable “i” is set to “0” (step A4) Next, it is determined whether the remainder c(0)×10 (=10) can be exactly divided by the denominator “b” (=17) (step A5).

When determined that the remainder c(0)×10 (=10) cannot be exactly divided by the denominator “b” (=17) (step A5: NO) the variable “i” is incremented by one, the quotient “0” is substituted into q(1), and the remainder “10” is substituted into c(1) (step A6) Next, it is determined whether the remainder c(i) coincides with any of c(k) of the past remainders c(0) to c(i−1) (step A7).

In the example described herein, it should be determined that the current remainder c(1) (=10) does not coincide with any of the past remainders c(0) (1) to c(i−1) (=1) (step A7: NO). Accordingly, the process returns to step A5, in which determined whether the current remainder c(1)×10 (=100) can be exactly divided by the denominator “b” (=17).

When determined that the current remainder c(1)×10 (=100) cannot be exactly divided by the denominator “b” (=17) (step A5: NO), the variable “i” is incremented by one, the quotient “5” is substituted into q(2), and the remainder “15” is substituted into c(2) (step A6). Next, it is determined whether the remainder c(2) (=15) coincides with any of c(k) of the past remainders c(0) (=1) to c(i−1) (=10) (step A7).

In the example described herein, it should be determined that the current remainder c(2) (=15) does not coincide with any of the past remainders c(0) (−1) to c(i−1) (=10) (NO is determined again at step A7), the process returns again to step A5, in which determined whether the current remainder c(2)×10 (=150) can be exactly divided by the denominator “b” (=17).

When determined that the current remainder c(2)×10 (=150) cannot be exactly divided by the denominator “b” (=17) (step A5: NO), the variable “i” is incremented by one, the quotient “8” is substituted into (3), and the remainder “14” is substituted into c(3) (step A6) Next, it is determined whether the remainder c(3) (=14) coincides with any of c(k) of the past remainders c(0) (=1) to c(i−1) (=15) (step A7).

In the example described herein, it should be determined that the current remainder c(3) (=14) does not coincide with any of the past remainders c(0) (=1) to c(i−1) (=15) (NO is determined again at step A7), the process returns again to step A5, in which determined whether the current remainder c(3)×10 (=140) can be exactly divided by the denominator “b” (=17).

The division process of steps A5-A7 is thereafter repeated in the same manner. When the quotients q(0) to q(17) (=0.05882352941176470) and a remainder c(17) (=10) are obtained at step A6, it should be determined that the remainder c(17) (=10) coincides with the past remainder c(1) (=10 c(k)) (step A7: YES).

As a result, q(k) to q(i−1), that is, q(1) to q(16) (=0588235294117647), of the quotients q(0) to q(17) (=0.05882352941176470) is set as a periodic block (step A8). The quotients q(0) to q(16) (=0.{0588235294117647}) having the periodic block q(1) to q(16) (=0588235294117647) are stored in the work area 17a of the RAM 17 (step S9).

Next, the number of digits of the periodic block is calculated by subtracting the value “k” from the value “i” (i−k (=16)) and stored in the work area 17a (step A10).

On the other hand, when determined that the remainder c(i)×10 can be exactly divided by the denominator “b” in the division processing of steps A5-A7 (step A5: YES), the quotients q(0) to q(i) which represent an integer or a non-repeating decimal is stored in the work area 17a of the RAM 17 (step A11).

Upon the completion of the conversion process (step SA) it is determined whether the quotient stored in the work area 17a of the RAM 17 is a repeating decimal for which a periodic block is set (step S4). When determined that the quotient is an integer stored at step A3 or a non-repeatinq decimal stored at step A11 (step S4: NO), the quotient (integer or non-repeating decimal) is displayed on the display device 19 (step S5).

On the other hand, when determined that the quotient stored in the work area 17a of the RAM 17 is a repeating decimal for which a periodic block is set (i.e., the repeating decimal 0.{0588235294117647} that was stored at step A9) (step S4: YES) as shown in section (D) in FIG. 6, the quotient 0.{0588235294117647} is displayed on the display device 19 in such a manner that a symbol(s) (see FIGS. 2-3D) indicating the periodic block {0588235294117647} is added (the symbol(s) corresponds to a country or region that was selected and set in advance as the notation setting information 17b) (step S6) The number (=16) of digits of the periodic block {0588235294117647} that was stored at step A10 is displayed so as to read “The number of repeating digits=16” (step S7).

In the example described herein, a country “Japan” is selected and set as the notation setting information 17b. Therefore, dots DS and DE are respectively added at the start digit and the end digit of the periodic block {0588235294117647}.

Next, it is determined (step S8) whether the repeating decimal (0.{0588235294117647}) to be displayed on the display device 19 overflows the number of displayable digits. When determined that the repeating decimal overflows the number of displayable digits (step S8: YES) a displayable part “0.{0588235294117” of the repeating decimal is displayed on the display device 19, as shown in section (D) in FIG. 6, and an scroll indicator (in this example, MR) indicating that the displayed decimal number is scrollable to the right toward a hidden part “647” is also displayed (step S9).

When the right cursor key 18cr which corresponds to the direction indicated by the scroll indicator MR is pressed (step S10: YES) while the part “0.{0588235294117” of the repeating decimal is displayed together with the scroll indicator MR, the displayed repeating decimal is scrolled in the direction of the pressed key and the hidden tail part “647” is displayed to scroll in with the dot DE added at the end digit as shown in section (E) in FIG. 6 (step S11). Conversely, when the head part “0.0” of the repeating decimal is not displayed and hidden (undisplayed), the scroll indicator ML is displayed indicating that the repeating decimal is scrollable to the left toward the hidden head part.

As described above, according to the electronic calculator 10 thus configured, when the enter key “=” 18d is pressed while a fractional number “ 1/17” is input and displayed on the display device 19, processing of dividing the numerator of the fraction by its denominator is performed, whereby quotients are obtained, which represents an integer or a decimal number. Since in this case the quotient is calculated as the repeating decimal (0.{0588235294117647}), it is displayed on the display device 19 in such a manner that a symbol(s) (in the case of the Japanese style, dots DS and DE) indicating the periodic block {0588235294117647} is added. When the number of digits of the repeating decimal (0.{0588235294117647}) overflows the displayable digits of the display device 19, the scroll indicator MR or ML indicating that the displayed decimal number is scrollable toward a hidden part (undisplayed part) is also displayed. When the cursor key 18c corresponding to the scroll indicator MR or ML is pressed, the displayed repeating decimal is scrolled toward the direction corresponding to the pressed cursor key 18c and the hidden part (undisplayed part) is displayed to scroll in. As a result, a repeating decimal obtained by converting an arbitrary fractional number can be displayed with its periodic block being clearly indicated. In addition, even if the periodic block of a repeating decimal to be displayed is too long to be fully displayed on the display device 19, the user can easily recognize the entire digits of the repeating decimal.

Furthermore, according to the electronic calculator 10 thus configured, as for the symbol(s) to indicate aperiodic block, a country or a region where the electronic calculator 10 is to be used is selected and set in advance as the notation setting information 17b. The symbol(s) corresponding to the preset country or region is selectively read out from the periodic block notation database 12c and used for indication. Therefore, a repeating decimal can be displayed in a prescribed notation that is suitable for the target country or region in which the electronic calculator 10 is to be used.

Still further, according to the electronic calculator 10 thus configured, the number of digits of a periodic block of a repeating decimal is also displayed when the repeating decimal is displayed with its periodic block indicated by a symbol(s). This allows the user to easily recognize the whole digits of a repeating decimal to be displayed even in a case where the periodic block of the repeating decimal is too long to be fully displayed on the display device 19.

The process performed by the processor 11 of the electronic calculator 10 according to the embodiment, such as the process shown in FIGS. 4 and 5 can be distributed by storing a computer-executable program set including the conversion program and the determination program in the external storage medium 13. The storage medium 13 may be a memory card (e.g., ROM card or RAM card), a magnetic disk (e.g., floppy disk or hard disk), an optical disc (e.g., CD-ROM or DVD), or a semiconductor memory The processor 11 of the electronic calculator 10 reads the programs into the storage device 12 or 17 from the external storage medium 13 and operation of the electronic calculator 10 is controlled by the processor 11 in accordance with the thus-read programs.

The program for performing the above described process can be transmitted over a communication network (public lines) N in a form of program code. The above-described process can also be realized by taking the programs into the electronic calculator 10 by the network interface 16 which is connected to the communication network N.

In the above described embodiment, the electronic calculator 10 is configured that the processor 11 operates with a memory device (ROM 12 and RAM 17) in accordance with the conversion program and the determination program to serve as a plurality of modules for performing the process shown in FIGS. 4-6, the modules including: a fractional number display module that controls the display device (display device 19) to display a given fractional number; a conversion module that converts the fractional number into a decimal number; a repeating decimal determination module that determines whether the decimal number is a repeating decimal; a decimal number display module that controls the display device to display the decimal number; a periodic block indication module that controls the display device to display a symbol with the decimal number when the repeating decimal determination module determines that the decimal number is the repeating decimal, the symbol indicating a periodic block included in the repeating decimal; a display digit determination module that determines whether the number of digits included in the repeating decimal overflows the number of digits displayable by the display device; an indicator display module that controls the display device to display a scroll indicator indicating that the displayed repeating decimal is scrollable when the display digit determination module determines that the number of digits included in the repeating decimal overflows the number of digits displayable by the display device; and a scrolling display module that controls the display device to display an undisplayed part of the repeating decimal to scroll in when a scroll command is input by the user through the user interface while the scroll indicator is displayed. The processor 11 also operates to serve as a digit number display module that controls the display device to display the number of digits included in the periodic block.

It is to be understood that the present invention is not limited to the specific embodiments described above and that the invention can be embodied with the components modified without departing from the spirit and scope of the invention. The invention can be embodied in various forms according to appropriate combinations of the components disclosed in the embodiments described above For example, some components may be deleted from all components shown in the embodiments. Further, the components in different embodiments may be used appropriately in combination.

What is claimed is:

1. An electronic calculator comprising:
a display device that displays characters including numerical characters;
a user interface that allows a user to input operational commands;
a fractional number display module that controls the display device to display a given fractional number;
a conversion module that converts the fractional number into a decimal number;
a repeating decimal determination module that determines whether the decimal number is a repeating decimal;
a decimal number display module that controls the display device to display the decimal number;
a periodic block indication module that controls the display device to display a symbol with the decimal number when the repeating decimal determination module determines that the decimal number is the repeating decimal, the symbol indicating a periodic block included in the repeating decimal;
a display digit determination module that determines whether the number of digits included in the repeating decimal overflows the number of digits displayable by the display device;
an indicator display module that controls the display device to display a scroll indicator indicating that the displayed repeating decimal is scrollable when the display digit determination module determines that the number of digits included in the repeating decimal overflows the number of digits displayable by the display device; and
a scrolling display module that controls the display device to display an undisplayed part of the repeating decimal to scroll in when a scroll command is input by the user through the user interface while the scroll indicator is displayed.

2. The electronic calculator according to claim 1, wherein the periodic block indication module comprises:
a symbol storing module that stores a plurality of types of symbols for indicating the periodic block to be used in each countries or regions where the electronic calculator is used; and
a symbol setting module that sets one of the plurality of types of symbols to be used for indicating the periodic block in accordance with a setting command input by the user through the user interface; and
wherein the periodic block indication module controls the display device to display the symbol of the type set by the symbol setting module with the decimal number when the repeating decimal determination module determines that the decimal number is the repeating decimal.

3. The electronic calculator according to claim 1 further comprising a digit number display module that controls the display device to display the number of digits included in the periodic block.

4. The electronic calculator according to claim 2 further comprising a digit number display module that controls the display device to display the number of digits included in the periodic block.

5. A computer-readable storage medium containing a sequence of instructions for a program executable by a computer system, the program comprising:
instructions for controlling a display device to display characters including numerical characters;
instructions for allowing a user to input operational commands;
instructions for controlling the display device to display a given fractional number;
instructions for converting the fractional number into a decimal number;
instructions for determining whether the decimal number is a repeating decimal;
instructions for controlling the display device to display the decimal number;
instructions for controlling the display device to display a symbol with the decimal number when determined that the decimal number is the repeating decimal, the symbol indicating a periodic block included in the repeating decimal;
instructions for determining whether the number of digits included in the repeating decimal overflows the number of digits displayable by the display device;
instructions for controlling the display device to display a scroll indicator indicating that the displayed repeating decimal is scrollable when determined that the number of digits included in the repeating decimal overflows the number of digits displayable by the display device; and
instructions for controlling the display device to display an undisplayed part of the repeating decimal to scroll in when a scroll command is input by the user through the user interface while the scroll indicator is displayed.

6. An electronic calculator comprising:
a display device that displays characters including numerical characters;
a user interface that allows a user to input operational commands;
a memory device that stores data for a calculation; and
a processor that is operable with the memory device to:
perform the calculation to convert a fractional number into a decimal number;
control the display device to display the decimal number, when the decimal number is a repeating decimal, with a symbol indicating a periodic block included in the repeating decimal;
control the display device to display a scroll indicator indicating that the displayed repeating decimal is scrollable when the number of digits included in the repeating decimal overflows the number of digits displayable by the display device; and
control the display device t display an undisplayed part of the repeating decimal to scroll in when a scroll command is input by the user through the user interface while the scroll indicator is displayed.
